(19) United States
(12) Patent Application Publication
(10) Pub. No.: US 2017/0269019 A1
(43) Pub. Date: Sep. 21, 2017

(54) Reusable Portable Reversible Hydrogen Electrode for Electrochemical Systems

(71) Applicant: NISSAN NORTH AMERICA, INC., Franklin, TN (US)

(72) Inventor: Cenk Gumeci, Walled Lake, MI (US)

(21) Appl. No.: 15/071,468

(22) Filed: Mar. 16, 2016

(51) Int. Cl. G01N 27/30; C25B 1/04

(52) U.S. Cl. CPC G01N 27/301; C25B 1/04

(57) ABSTRACT

A method of making a reversible hydrogen electrode comprises filling a housing with electrolyte, the housing having an open end, a closed end and a platinum wire having an internal portion in the housing and an external portion extending through the closed end to an exterior of the housing. The housing is inverted into a container of electrolyte and a counter electrode is placed into the container of electrolyte, the counter electrode being metal. A power source is attached to the external portion of the platinum wire and the counter electrode. The power source is run for a period of time to produce electrolysis. Hydrogen is formed at the internal portion of the platinum wire and oxygen is formed at the counter electrode. A single hydrogen bubble is formed in the housing, the platinum wire extending through the single hydrogen bubble.

### TECHNICAL FIELD

This disclosure relates to an apparatus for measuring catalyst activity, and in particular to a reusable portable reversible hydrogen electrode for use in systems such as three-electrode electrochemical cells.

### BACKGROUND

Electrochemical measurements typically use a commercially available reference electrode, such as Silver/silver chloride or a calomel electrode (Hg/HgCl₂). However, when these reference electrodes are used for proton exchange membrane fuel cell catalyst tests on three-electrode systems, such reference electrodes introduce contamination. An alternative electrode, a reversible hydrogen electrode, can be used but requires continuous bubbling hydrogen gas during the course of experimentation.

### SUMMARY

Disclosed herein is a reversible hydrogen electrode that is portable and reusable. Also disclosed is a method of making the reversible hydrogen electrode.

As disclosed, a method of making a reversible hydrogen electrode comprises filling a housing with electrolyte, the housing having an open end, a closed end and a platinum wire having an internal portion in the housing and an external portion extending through the closed end to an exterior of the housing. The housing is inverted into a container of electrolyte and a counter electrode is placed into the container of electrolyte, the counter electrode being metal. A power source is attached to the external portion of the platinum wire and the counter electrode. The power source is run for a period of time to produce electrolysis. Hydrogen is formed at the internal portion of the platinum wire and oxygen is formed at the counter electrode. A single hydrogen bubble is formed in the housing, the platinum wire extending through the single hydrogen bubble.

The reversible hydrogen electrode comprises a housing having an open end and a closed end, a platinum wire in the housing and extending through the closed end external to the housing, electrolyte in the housing, and a single hydrogen bubble in the housing, the platinum wire extending through the single hydrogen bubble.

These and other aspects of the present disclosure are disclosed in the following detailed description of the embodiments, the appended claims and the accompanying figures.

### BRIEF DESCRIPTION OF THE DRAWINGS

The invention is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 illustrates a portable reversible hydrogen electrode as disclosed herein.

FIGS. 2A-2C illustrate a method of making the portable reversible hydrogen electrode of FIG. 1.

FIG. 3 is a flow diagram of the method of making the portable reversible hydrogen electrode.

FIG. 4 is a three-electrode electrochemical cell in which the reversible hydrogen electrode can be used.

FIG. 5A shows cyclic voltammograms (CVs) (first two cycles) of polycrystalline platinum (Pt) electrode in nitrogen saturated 0.1 M HClO4 with a scan rate of 50 mV/s using two different electrodes.

FIG. 5B shows linear sweep voltammograms of Pt electrode in oxygen saturated 0.1 M HClO4 with a rotation sweep of 1600 rpm and scan rate of 10 mV/s.

### DETAILED DESCRIPTION

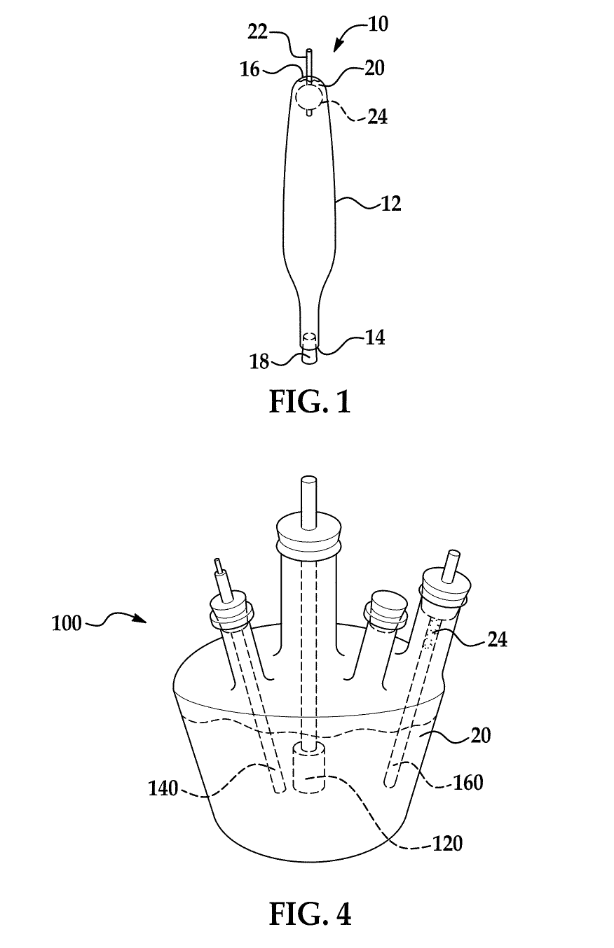

Disclosed herein is a reversible hydrogen electrode. Unlike a standard hydrogen electrode, the measured potential of the reversible hydrogen electrode does not change with pH, so it can be directly used in the electrolyte. Reversible hydrogen electrodes require a constant hydrogen source. As illustrated in FIG. 1, the reversible hydrogen electrode 10 has a housing 12 having an open end 14 and a closed end 16. As illustrated in FIG. 1, the open end 14 has a stopper 18 in it to prevent liquid electrolyte 20 from leaking from the housing 12. A platinum wire 22 extends through the closed end 16 of the housing 12 and into the housing 12. A single hydrogen bubble 24 is in the housing 12. The platinum wire 22 extends through the single hydrogen bubble 24.

The hydrogen bubble 24 allows for the reuse and transportation of the reversible hydrogen electrode 10, as no external hydrogen source is needed to feed hydrogen over the platinum wire 22. Because no hydrogen supply is needed during use of the reversible hydrogen electrode 10, testing costs are reduced and safety is improved. In addition, because no hydrogen supply is needed during use of the reversible hydrogen electrode 10, the reversible hydrogen electrode 10 can be used in many different electrochemical systems, such as proton exchange fuel cell catalyst tests, flow batteries, direct methanol fuel cell applications, supercapacitors and others. The reversible hydrogen electrode 10 is also pH independent, and can be used in either acidic or basic electrolytes.

The housing 12 can be glass, a hard, moldable plastic such as polycaprolactone, or any other material known to those skilled in the art that will hold the electrolyte and into which the platinum wire can be sealably inserted. The housing 12 can be of any suitable size and shape to contain the electrolyte 20 and to work with the testing systems using the reversible hydrogen electrode 10.

The electrolyte 20 can be an acidic solution such as perchloric acid, sulfuric acid, phosphoric or trifluoromethanesulfonic acid, as non-limiting examples. The electrolyte 20 can also be a basic solution of potassium hydroxide or sodium hydroxide.

The platinum wire 22 does not have to be an actual “wire” but can be any piece of platinum of the requisite size, such as a foil or a mesh. The platinum wire 22 can be covered with platinum black, or nanometric particles deposited on the platinum wire.

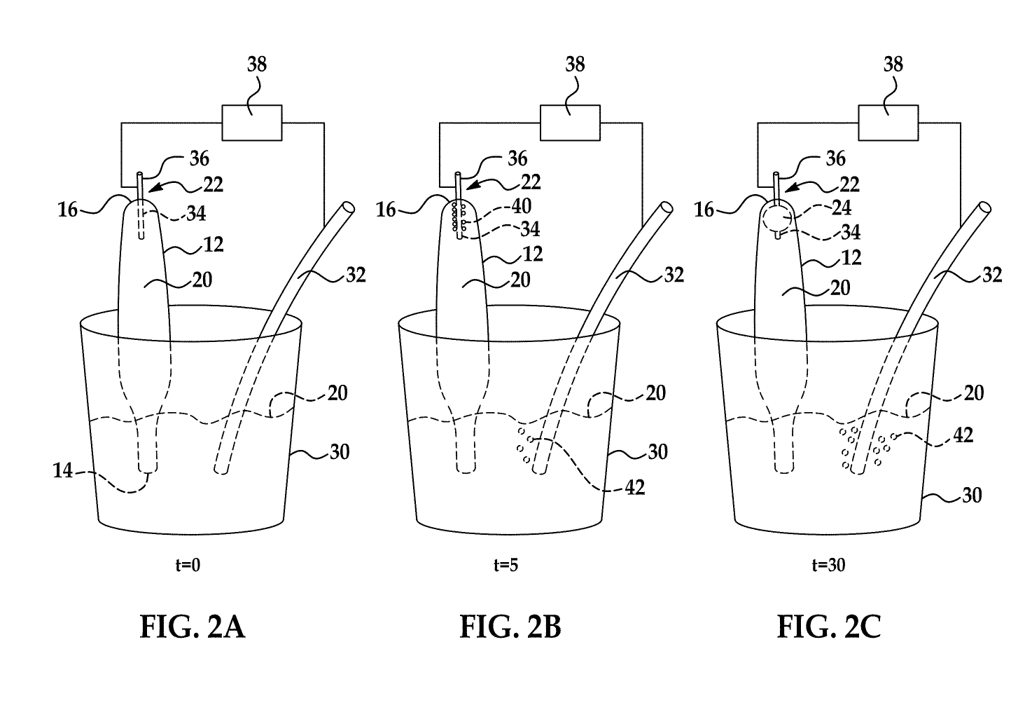

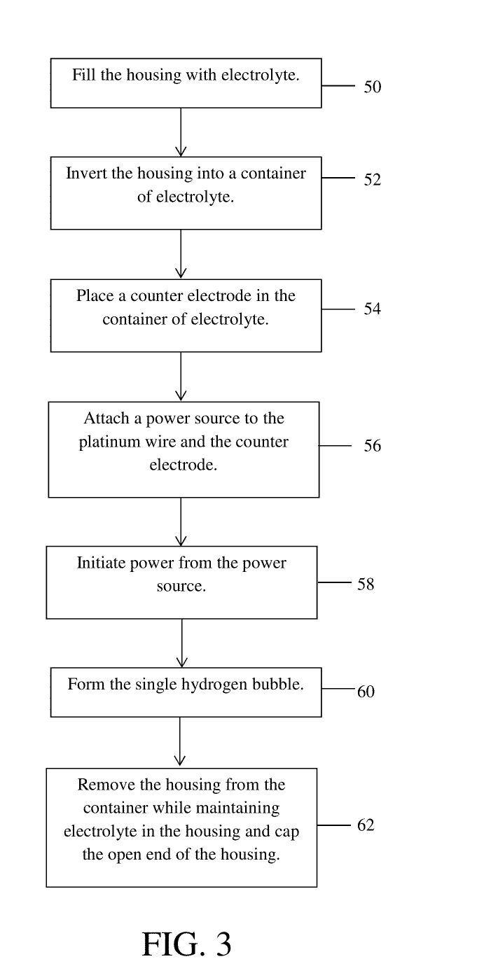

Also disclosed herein is a method of making the reversible hydrogen electrode 10. FIGS. 2A-2C are schematics illustrating the method and FIG. 3 is a flow diagram of the method. In step 50, the housing 12 is filled with electrolyte 20 through the open end 14. The housing 12 already has the platinum wire 22 inserted in the closed end 16 of the housing 12. As a non-limiting example, the housing 12 can be glass, which is heated to a point where the platinum wire 22 can be inserted through the closed end 16, which will then be sealed upon cooling.

In step 52 of FIG. 3, the housing 12 is inverted into a container 30 of the electrolyte 20, and a counter electrode 32 is placed into the container 30 of electrolyte 20 in step 54. The counter electrode 32 is a metal. As a non-limiting example, the counter electrode 32 can be copper, silver or platinum.

The platinum wire 22 has an internal portion 34 in the housing 12 and an external portion 36 extending through the closed end 16 to an exterior of the housing 12. A power source 38 is attached to the external portion 36 of the platinum wire 22 and to the counter electrode 32 in step 56, as illustrated in FIG. 2A and at time t=0. The power source can be, for example, a 9-volt battery. The power source is turned on in step 58.

Power from the power source 38 initiates electrolysis, which is the interchange of atoms and ions by removal or addition of electrons caused from the circuit created. The power source is run for a period of time. During the electrolysis, hydrogen 40 is initially formed at the internal portion 34 of the platinum wire 22 and oxygen 42 is formed at the counter electrode 32, as illustrated in FIG. 2B. The time t=5 is provided as an example and is not meant to be limiting. At period t=5 in FIG. 2B, small bubbles of hydrogen 40 form along the internal portion 34 of the platinum wire 22. As the electrolysis continues, a single hydrogen bubble 24 is formed in the housing 12 as the small bubbles of hydrogen agglomerate. The single hydrogen bubble 24 is formed in step 60 so that the internal portion 34 of the platinum wire 22 is extending through the single hydrogen bubble 24. FIG. 2C illustrates the formation of the single hydrogen bubble 24. Although FIG. 2C shows the single hydrogen bubble 24 forming at time t=30, this is provided as an example and is not meant to be limiting. The power source 38 should be run for the period of time sufficient to allow hydrogen bubbles that form along the internal portion of the platinum wire to aggregate into the one single hydrogen bubble 24. For example, the power source 38 should be operated for a period of time between fifteen seconds and sixty seconds. The single hydrogen bubble 24 will have a diameter between one and three centimeters.

The reversible hydrogen electrode 10 is then removed from the container 30 in step 62 while maintaining the electrolyte in the housing and the open end 14 is capped with the stopper 18. The reversible hydrogen electrode 10 is ready for use in a testing apparatus and is portable without the need for a hydrogen supply during testing.

As a non-limiting example, FIG. 4 illustrates the use of the reversible hydrogen electrode 10 disclosed herein. The testing apparatus in FIG. 4 is a three-electrode electrochemical cell 100. Three-electrode electrochemical cells 10 using stationary electrode or rotating disk electrode measurements can be used in the evaluation of catalysts. The three-electrode electrochemical cell 100 comprises a working electrode 120, shown here as a rotating-disk electrode, a counter electrode 140, and the reversible hydrogen electrode 10 as a reference electrode 160. The working electrode 120, also known as the electrocatalyst, catalyst, test or indicating electrode, is the electrode at which the electrochemical phenomena (reduction or oxidation) being investigated are taking place. The reference electrode 160 is the electrode whose potential is constant enough that it can be taken as the reference standard against which the potentials of the other electrodes present in the cell can be measured. The counter electrode 140 serves as a source or a sink for electrons so that current can be passed from the external circuit through the cell. In general, the actual potential of the counter electrode 140 is typically not measured.

The three-electrode electrochemical cell 100 is filled to a predetermined level with the liquid electrolyte 20. Note that no hydrogen needs to be delivered to the reference electrode 160 as the reversible hydrogen electrode 10 has the single hydrogen bubble 24. In very general terms, an electric current is established between the working electrode 120 and the counter electrode 140. The electric potential (or difference in voltage) between the working electrode 120 and the counter electrode 140 due to the flow of current can then be measured. The reference electrode 160 generates a known voltage from which the actual value of the electric potential generated by working electrode 120 can be determined. The liquid electrolyte 20 can be tested for the precious metal used in the catalyst to determine activity of the catalyst.

When testing is complete, the reversible hydrogen electrode 10 disclosed herein can be transported to another test apparatus or reused in the same test apparatus to run additional tests.

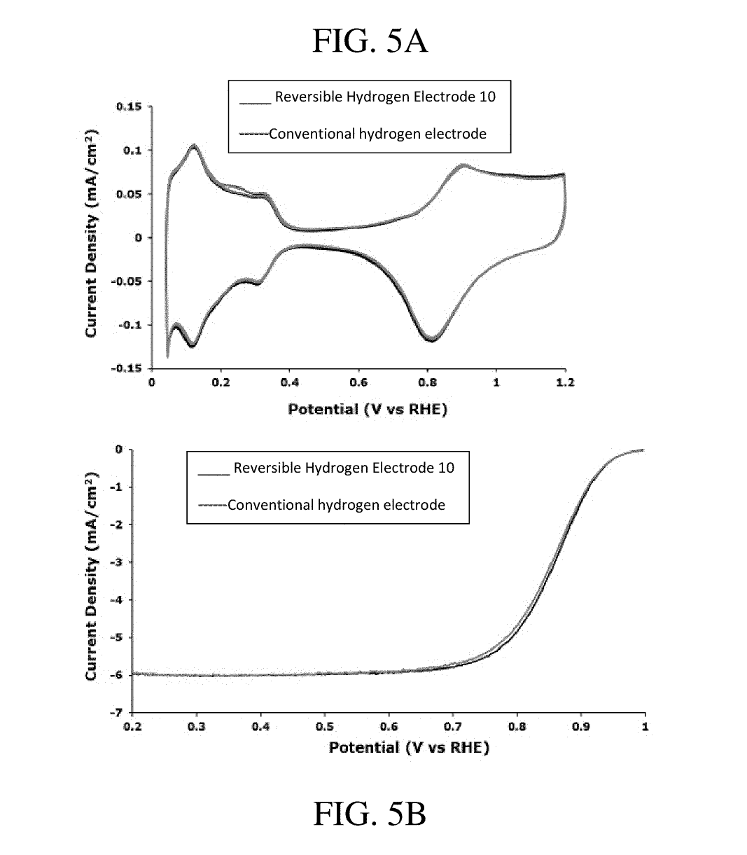

Hydrogen electrodes are often used to investigate oxygen reduction reaction (ORR) kinetics. The specific activity obtained from the linear sweep voltammograms provides a critical ORR activity benchmark. The disclosed reversible hydrogen electrode 10 was tested against a conventional hydrogen electrode using a continuous hydrogen feed. FIG. 5A shows cyclic voltammograms (CVs) (first two cycles) of the conventional hydrogen electrode having a polycrystalline platinum (Pt) electrode (with 0.196 cm diameter) in nitrogen saturated 0.1 M HClO4 with a scan rate of 50 mV/s using two different electrodes. Before obtaining CVs, the Pt electrode was conditioned with a scan rate of 500 mV/s for 50 cycles at a potential window of 0.05-1.4 V (RHE). FIG. 5B shows linear sweep voltammograms of Pt electrode in oxygen saturated 0.1 M HClO4 with a rotation sweep of 1600 rpm and scan rate of 10 mV/s. Before obtaining linear sweep voltammograms, Pt electrode was conditioned with a scan rate of 500 mV/s for 50 cycles at a potential window of 0.05-1.4 V (RHE).

FIG. 5A illustrates that the obtained CVs are almost identical using the reversible hydrogen electrode 10 disclosed herein against a conventional hydrogen electrode using a continuous hydrogen feed. FIG. 3B shows that the diffusion current density (between 0.2-0.7 V) is nearly identical ˜6 mA/cm2, and the kinetic current densities obtained at 0.9 V, after background and IR corrections, are also nearly identical for the disclosed reversible hydrogen electrode 10 versus a conventional hydrogen electrode using a continuous flow of hydrogen.

The words “example” or “exemplary” are used herein to mean serving as an example, instance, or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A or B, X can include A alone, X can include B alone or X can include both A and B. In addition, the articles “a” and “an” as used in this application and the appended claims should generally be construed to mean “one or more” unless specified otherwise or clear from context to be directed to a singular form.

The above-described embodiments, implementations and aspects have been described in order to allow easy understanding of the present invention and do not limit the present invention. On the contrary, the invention is intended to cover various modifications and equivalent arrangements included within the scope of the appended claims, which scope is to be accorded the broadest interpretation so as to encompass all such modifications and equivalent structure as is permitted under the law.

Other embodiments or implementations may be within the scope of the following claims.

What is claimed is:

1. A method of making a reversible hydrogen electrode comprising:
filling a housing with electrolyte, the housing comprising:
an open end;
a closed end; and
a platinum wire having an internal portion in the housing and an external portion extending through the closed end to an exterior of the housing;
inverting the housing into a container of electrolyte;
placing an end of a counter electrode into the container of electrolyte, the counter electrode being metal;
attaching a power source to the external portion of the platinum wire and the counter electrode; and
running the power source for a period of time to produce electrolysis, wherein hydrogen is formed at the internal portion of the platinum wire and oxygen is formed at the counter electrode.

2. The method of claim 1, wherein running the power source is done for the period of time sufficient to allow hydrogen bubbles that form along the internal portion of the platinum wire to aggregate into the one single hydrogen bubble.

3. The method of claim 2, wherein the period of time is between fifteen seconds and sixty seconds.

4. The method of claim 2, wherein the one single hydrogen bubble has a diameter between one and three centimeters.

5. The method of claim 1, wherein the electrolyte is an acid.

6. The method of claim 1, wherein the electrolyte is a base.

7. The method of claim 1, wherein the counter electrode is one of platinum, copper or silver.

8. The method of claim 1, further comprising:
closing the open end of the housing; and
removing the housing from the container of electrolyte, the housing being portable to use with test systems without the need for additional hydrogen for the reversible hydrogen electrode.

9. A reversible hydrogen electrode comprising:
a housing having an open end and a closed end;
a platinum wire in the housing and extending through the closed end external to the housing;
electrolyte in the housing; and
a single hydrogen bubble in the housing, the platinum wire extending through the single hydrogen bubble.

10. The reversible hydrogen electrode of claim 9, wherein the one single hydrogen bubble has a diameter between one and three centimeters.

11. The reversible hydrogen electrode of claim 9, wherein the electrolyte is an acid.

12. The reversible hydrogen electrode of claim 9, wherein the electrolyte is a base.

13. The reversible hydrogen electrode of claim 9, configured for use without additional hydrogen.

14. A three-electrode electrochemical cell comprising the reversible hydrogen electrode of claim 13.
